(19) United States
(12) Patent Application Publication
(10) Pub. No.: US 2013/0252319 A1
(43) Pub. Date: Sep. 26, 2013

(54) BIOSENSOR FOR MEASURING STRESS BASED ON ELETRICAL DEVICE AND MEASUREMENT METHOD THEREOF, AND EMOTION-ON-A-CHIP AND MEASURING APPARATUS THEREOF

(71) Applicant: INDUSTRY-ACADEMIC COOPERATION FOUNDATION YONSEI UNIVERSITY, (US)

(72) Inventors: Hyo il JUNG, Seoul (KR); Jung Hyun LEE, Goyang-si (KR); Hee Jo LEE, Seoul (KR)

(73) Assignee: INDUSTRY-ACADEMIC COOPERATION FOUNDATION YONSEI UNIVERSITY, Seoul (KR)

(21) Appl. No.: 13/848,167

(22) Filed: Mar. 21, 2013

(30) Foreign Application Priority Data
Mar. 21, 2012 (KR) 10-2012-0028617
Apr. 24, 2012 (KR) 10-2012-0042879

(51) Int. Cl. G01N 27/02

(52) U.S. Cl. CPC G01N 27/021
USPC 435/287.2; 216/13

(57) ABSTRACT

Biosensor and measurement method thereof, where cortisol in saliva is measured by immobilizing antibody for measuring the cortisol and reading an electrical signal generated when the antibody is bound to the cortisol using a miniaturized microwave resonant device, are provided. Emotion-on-a-chip and measurement apparatus thereof, where various emotion indexes are measured on the chip by measuring emotion index target material in real time from body fluid, are provided. Emotion diagnosis system is provided, which includes an emotion-on-a-chip where a biosensor detecting emotion signal including stress is mounted; and an emotion diagnosis apparatus converting the emotion signal from the emotion-on-a-chip into emotion level and outputting the emotion level, where the emotion-on-a-chip includes a ring resonator on dielectric layer; and a microstrip transmission line on the dielectric layer as straight signal line.

### BACKGROUND OF THE INVENTION

1. Field of the Invention

In one aspect, the present invention relates to a biosensor for measuring stress based on an electrical device, in which cortisol in saliva which is an index for measuring stress is detected using a miniaturized microwave resonant device, and more specifically, to a biosensor and a measurement method hereof, in which cortisol in saliva can be easily and rapidly measured by immobilizing an antibody for measuring the cortisol in saliva and reading an electrical signal which is generated when the antibody is bound to the cortisol using a miniaturized microwave resonant device, and in another aspect, the present invention related to an emotion-on-a-chip (EOC) for accurately measuring emotion of a human being in real-time using a body fluid such as blood, salvia, urine, sweat or the like, and more specifically, to an emotion-on-a-chip and a measurement apparatus thereof, in which various emotion indexes are measured on the chip by measuring an emotion index target material (a metabolite, a biogenic hormone or the like) such as catecholamine, cortisol or the like in real-time from a body fluid such as blood, saliva, urine, sweat or the like.

2. Background of the Related Art

Recently, it has been tried to measure emotion of a human being through a body fluid based on perspective of psychoneuroimmunoendocrinology (changes in mind accompany changes in body). Stress has been studies most frequently until present in regard to changes in a body, and a material called as cortisol is widely known as an index for measuring the stress.

Conventional methods of measuring the cortisol include High Performance Liquid Chromatography (HPLC), fluorometric assay, reverse phase chromatography and the like.

The HPLC is a representative method for separation or determination of various organic compounds, i.e., the HPLC is an apparatus for analyzing components of a sample using ultraviolet or visible ray absorption or a detector for detecting fluorescent, in which the components of the sample are separated by mixing the sample with a mobile phase and passing the mixture through The stationary phase while flowing a fluid (the mobile phase) such as water, an organic solvent or the like into a column the stationary phase) where a filler is pushed in.

The fluorometric assay is a method of detecting and measuring a small amount of fluorescent material,

A difference in polarity is required between the mobile phase and the stationary phase for the separation of the HPLC, and if the polarity of the mobile phase is high and the polarity of the stationary phase is low, it is called as reverse phase chromatography.

The High Performance Liquid Chromatography (HPLC), the fluorometric assay and the reverse phase chromatography are inadequate for the point of care testing (POCT) since all of them are time-consuming, expensive and not portable.

Accordingly, the present invention proposes a biosensor and a measurement method thereof, in which a miniaturized microwave resonant device is fabricated, and cortisol in saliva of a patient can be easily and rapidly measured by immobilizing an antibody which can measure the cortisol in saliva and reading a resonant signal which is which is generated when the antibody is bound to the cortisol.

Meanwhile, according to another aspect of the present invention, a biochip which measures emotion of a human being in real-time using a body fluid such as blood, saliva, sweat or the like will be hereinafter referred to as an emotion-on-a-chip (EOC).

Science of emotion and sensibility is a scientific and engineering domain which gradually occupies important positions in modern society. Emotion is a high-dimensional psychological experience undergone inside of a human being against a physical or chemical stimulus from outside, which may be a complex feeling of joy, sorrow, comfort, discomfort and the like. However, the greatest difficulty in studying the emotion is a problem of measurement. Existing emotion measurements are limited to a self report, an interview, a response of an electroencephalogram and autonomic nervous system, a cardiovascular activity and the like, and it still may not be considered as being an objective measurement.

If a semiconductor process is used a biomaterial (DNA or protein) is immobilized on a chip in which an electronic circuit is integrated, and this can be used for basic researches of life science and medical diagnoses.

A DNA-on-a-chip (or a DNA chip), a protein-on-a-chip (or a protein chip) and a cell-on-a-chip Or a cell chip) respectively named by putting a DNA, a protein and a cell on the chip are used for diagnosing human diseases including cancers,

As a concept of making a general biochemical experiment on a chip, such as performing separation, response, mixture, synthesis, analysis or the like on a chip, s adopted in early 1990s, the concept of a laboratory on a chip, i.e., a lab-on-a-chip, begins to be emerged. Since the lab-on-a-chip technique has advantages such as a short response time, use of an extremely small amount of materials, miniaturization and the like, studies on the lab-on-a-chip are under progress in Japan, Korea and the like, starting from USA and Europe.

The emotion-on-a-chip proposed in the present invention may be referred to as a next-generation biochip technique which can immobilize a biomaterial that can measure an emotion index on a chip and measure an emotion index target material. (a metabolite, a biogenic hormone or the like) in real-time on the spot like the DNA chip, or perform a compound reaction of various emotion indexes on a chip like the lab-on-a-chip (LOC).

Measurement of emotion through a body fluid is measuring changes in the emotion through a biological marker which is expressed in a body fluid of a human being as a response to an external stimulus. For example, a degree of uneasiness is measured through a degree of secretion of catecholamine which is a hormone and a neurotransmitter reported as being closely related uneasiness, or stress is measured through concentration of cortisol.

Examination on the biological marker which shows a response only for a short moment and disappears, which is a work of diagnosing an emotional state by reading changes in the biological marker contained in sampled blood or urine through an experiment or analysis, is disadvantageous in that the biological marker is difficult to measure in a method available presently, and particularly, the measurement is possible only when the amount of a component used as the biological marker is larger than a predetermined level.

Currently, studies on a method of measuring emotion through a body fluid are less vitalized than the studies on a method of measuring emotion based on a neurological signal.

It is since that a marker of an emotion is not easy to read since various markers exposed in a body fluid simultaneously and comprehensively express all the situations occurring in a human body, i.e., situations of nervous, circulatory and digestive systems, as well as changes in emotion. Contrarily, if it is considered that emotion is related to recognition and sensation of a human being and all the situations in a human body, measurement of, emotion through a body fluid is very useful as a data for understanding emotion of a human being, and thus it is a field that should be studied with patience.

Particularly, studies on emotional biomarkers are in a very preliminary stage, and discovery and development of a considerably large number of emotional biomarkers contained in a body fluid should be accompanied with development of an emotion-on-a-chip, and to this end, development of an EOC for accurately measuring a single emotion index should be preceded,

Accordingly, there is provided an emotion-on-a-chip for measuring various emotion indexes on a chip by measuring an emotion index target material (a metabolite, a biogenic hormone or the like) such as catecholamine, cortisol or the like in real-time from a body fluid such as blood, salvia, urine, sweat or the like.

### SUMMARY OF THE INVENTION

Therefore, the present invention has been made in view of the above problems, and it is an object of the present invention to provide a biosensor and a measurement method thereof, in which cortisol in saliva can be easily and rapidly measured by immobilizing an antibody for measuring the cortisol in saliva on a miniaturized microwave resonant device and reading an electrical signal which is generated when the antibody is bound to the cortisol.

Another object of the present invention is to provide a biosensor and a measurement method thereof, which is provided with a structure capable of generating a resonant phenomenon at a specific frequency by positioning a split-ring resonator on the base of a microstrip transmission line.

Another object of the present invention is to provide a biosensor and a measurement method thereof, in which a time-varying electromagnetic field is generated by applying a microwave AC voltage at both ends of a microstrip signal line, and an induced electromagnetic force is generated when the time-varying electromagnetic field enters into the split-ring resonator, so that a resonance occurs.

Another object of the present invention is to provide a biosensor and a measurement method thereof, in which existence of cortisol is confirmed by immobilizing an antibody for recognizing the cortisol on a resonant device, measuring a resonant frequency after capturing the cortisol, and comparing the measured resonant frequency with a resonant frequency measured when the cortisol does not exist.

Another object of the present invention is to provide an emotion-on-a-chip. (EOC) and a measurement apparatus thereof, in which various emotion indexes are measured on the chip by measuring an emotion index target material (a metabolite, a biogenic hormone or the like) such as catecholamine, cortisol or the like in real-time from a body fluid such as blood, salvia, urine, sweat or the like.

Another object of the present invention is to provide an emotion-on-a-chip (EOC) and a measurement apparatus thereof, in which emotion is measured in an economical, convenient and quantitative method.

To accomplish the above objects, according to a first embodiment of the present invention, there is provided a cortisol detection sensor including: a ground layer formed of a metal at a bottom; a dielectric layer formed on the ground layer; and

masking layer formed on the dielectric layer and provided with a microstrip transmission line and a split-ring resonator.

In addition, the cortisol detection sensor of the present invention includes: a split-ring resonator positioned on the dielectric layer, having an inner circle, one side of which is open, and an outer circle, the other side of which is open; and a microstrip transmission line formed on the dielectric layer as a straight signal line installed to be spaced apart from one side of the split-ring resonator

In addition, in the cortisol detection sensor of the present invention, the split-ring resonator is positioned at one side of the microstrip transmission line on the dielectric layer, and existence of cortisol is detected by immobilizing an antibody for recognizing the cortisol on the split-ring resonator and measuring a resonant frequency after capturing the cortisol.

The split-ring resonator is positioned to he spaced apart from a center of the microstrip transmission line, and a width of a portion of the microstrip transmission line formed near the split-ring resonator is smaller than a width of the other portion of the microstrip transmission line that is not close to the split-ring resonator.

A portion of the microstrip transmission line formed near the split-ring resonator is formed as a high impedance line having impedance higher than that of the other portion of the microstrip transmission line that is not close to the split-ring resonator, and the high impedance line is matched at 30 ohm or higher.

A portion of the microstrip transmission line formed near the split-ring resonator is formed to have a surface density higher than that of the other portion of the microstrip transmission line that is not close to the split-ring resonator, and in addition, the portion of the microstrip transmission line formed near the split-ring resonator is formed to increase strength of a Lime-varying electromagnetic field.

The time-varying electromagnetic field is generated by applying a microwave AC voltage at both ends of the microstrip transmission line, and a resonance is occurred by an induced electromagnetic force which is generated when the time-varying electromagnetic field enters into the split-ring resonator.

The split-ring resonator is formed of an inner pattern, one side of which is open, and an outer pattern positioned outside of the inner pattern, the other side of which is open, and the inner pattern and the outer pattern are formed in any one of a circle, a rectangle, a triangle, an oval and a diamond.

The signal line of the split-ring resonator is formed of gold, and the microstrip transmission line is formed of gold.

Cys3-protein G is immobilized on the gold surface of the signal line of the split-ring resonator.

In addition, the present invention provides a method of fabricating a cortisol detection sensor, including: a first step of thinly spin-coating a dielectric substrate, both surfaces of which are coated with a copper thin film, with photoresist; a second step of dissolving a loosened photosensitive polymer layer after soaking the dielectric substrate in a developer; a third step of forming a printed circuit board (PCB) by printing a circuit in a form of a microstrip transmission line and a split-ring resonator on the dielectric substrate pre-oared in the second step, etching only copper in an open photoresist window by soaking the PCB in an etchant, and completely removing residual photoresist using acetone; and a fourth step of thinly coating the dielectric substrate etched in the third step with gold in order to detect cortisol binding.

The method of fabricating a cortisol detection sensor further includes a fifth step, after the fourth step, of coating the dielectric substrate, except both end points of the microstrip transmission line and the split-ring resonator.

The width of the signal line of the split-ring resonator is 0.05 to 0.5 mm, and a distance between two adjacent signal lines of the split-ring resonator is 0.05 to 0.2 mm, and a distance between the high impedance line and the split-ring resonator is 0.05 to 0.2 mm.

The distance between two adjacent signal lines of the split-ring resonator is a half of the width of the signal line of the split-ring resonator, and the distance between the high impedance line and the split-ring resonator is equal to the distance between the two adjacent signal lines of the split-ring resonator.

In addition, a cortisol measurement system of the present invention includes: a cortisol detection sensor including a split-ring resonator positioned at one side of a microstrip transmission line on a dielectric substrate and an antibody for recognizing cortisol immobilized on the split-ring resonator; and a network analyzer for detecting scattering parameters. (S-parameters) and a resonant frequency from the cortisol detection sensor.

### BRIEF DESCRIPTION OF THE DRAWINGS

FIG. 1 is a mimetic view showing the configuration a biosensor for measuring stress according to an embodiment of the present invention.

FIG. 2 is a view showing an example of an actually fabricated biosensor of the present invention.

FIG. 3 is a view illustrating a method of measuring cortisol using a biosensor of the present invention.

FIG. 4 is a graph comparing S₂₁ resonant characteristic of a sample detected by a biosensor of the present invention with a result of a simulation.

FIGS. 5A and 5B are views illustrating a sensor surface treatment process for measuring cortisol according to an embodiment of the present invention.

FIG. 6 is a view showing frequency changes according to cortisol-BAS concentration in an experiment using a biosensor of the present invention.

FIG. 7 is a mimetic view showing the configuration of a biosensor for diagnosing emotion according to an embodiment of the present invention.

FIG. 8 is a mimetic view showing the configuration of a biosensor according to another embodiment of the present invention.

FIGS. 9A to 9C are views showing examples a resonator that can be used as the ring resonator of FIG. 8.

FIG. 10 is a view illustrating a method of measuring cortisol using the biosensor (a cortisol detection sensor) of FIG. 8.

FIG. 11 is a graph comparing S₂₁ resonant characteristic of a sample detected by the biosensor of FIG. 8 with a result of a simulation.

FIGS. 12A and 12B are views illustrating a sensor surface treatment process for measuring cortisol at the biosensor of FIG. 8.

FIG. 13 is a view showing an example of an emotion-on-a-chip and an emotion diagnosis apparatus according to an embodiment of the present invention.

FIG. 14 is a block diagram schematically showing the configuration of the emotion diagnosis apparatus of FIG. 13.

FIGS. 15A to 15C are views showing a biochip of Japanese Laid-open Patent No 2007-17169.

FIG. 16 is a view showing a biochip of Japanese Laid-open Patent No. 2007-163440.

### DESCRIPTION OF SYMBOLS

10: Biosensor
30: Ground layer
60: Dielectric layer
100: Masking layer
120: Signal line
140: high-impedance line
200: Split-ring resonator
220, 240: Circular or rectangular signal line
300: Network analyzer
1005: Emotion-on-a-chip
1010: Biosample collection unit
1015: Sample mixing unit
1020; Emotion index separation and purification unit
1025: Emotion index separation unit
1030: Measurement unit
1035: Emotion index sensing unit
1040: Result output unit
1061: Substrate
1062: Fluid passage
1063: Oxidation electrode
1064: Reduction electrode
1065: Detection electrode
1066: Measurement sample
1067: Insulation layer
11.00: Masking layer
1110: Biosensor
1130: Ground layer
1160: Dielectric layer
1120: Signal line
1140: high-impedance line
1200: Split-ring resonator
1220, 1240: Circular or rectangular signal line
1300: Network analyzer
1400: Emotion diagnosis apparatus
1410: Display unit
1420: Key input unit
1450: Operation and processing unit
1460: Input frequency control unit.
1470: Resonant frequency detection unit

### DETAILED DESCRIPTION OF THE PREFERRED EMBODIMENT

Hereafter, a biosensor for measuring stress based on an electrical device and a measurement method thereof according to an embodiment of the present will be described in detail with reference to the accompanying drawings.

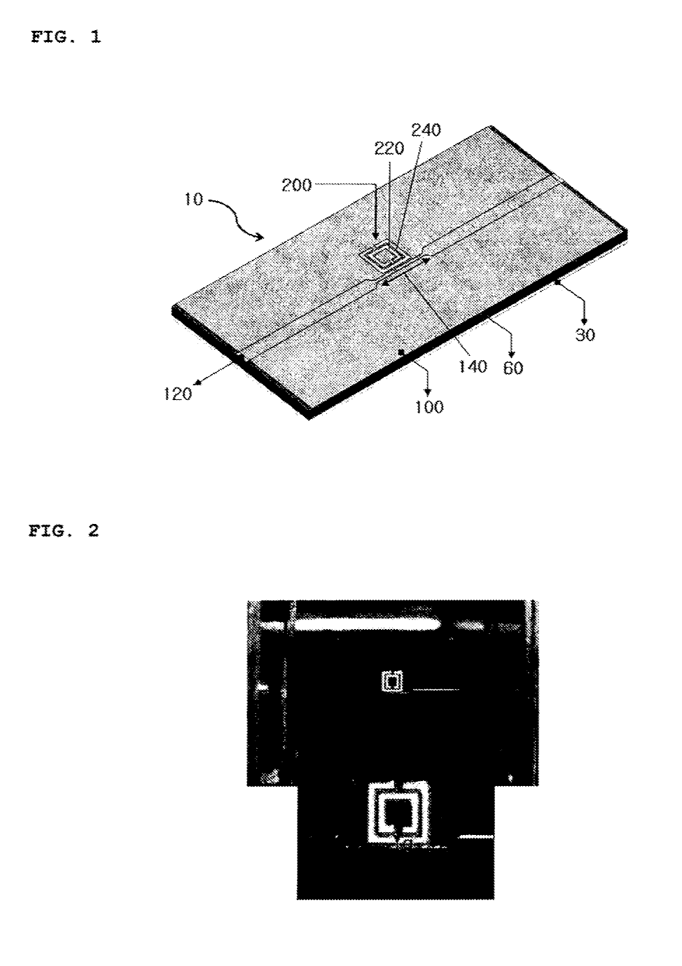

First, a first embodiment of the present will be described with reference to FIGS. 1 to 6.

FIG. 1 is a mimetic view showing the configuration biosensor for measuring stress according to a first embodiment of the present invention.

A biosensor 10 of the present invention is configured to detect cortisol and includes a ground layer 30, a dielectric layer 60 and a masking layer 100.

The ground layer 30 is formed of a metal at the bottom. The metal is a conductive metal.

The dielectric layer 60 is formed on the ground layer 30.

The masking layer 100 may be a power source layer having a small pattern and is formed on the dielectric layer. The masking layer 100 includes a signal line 120 and a split-ring resonator (SRR) 200.

The signal line 120 is a microstrip transmission line crossing the center of the masking layer 100, and a portion of the signal line 120 formed near the split-ring resonator 200 is a high impedance line 140.

The high impedance line 140 is a portion of the signal line 120 formed near the split-ring resonator 200 to have a width smaller than that of the other portion of the signal line 120 that is not close to the split-ring resonator 200. The high impedance line 140 strengthens surface current intensity by inserting a signal line having relatively high impedance into a signal line section matched at 50 ohm, and such a form may increase the strength of the time-varying electromagnetic field entering into the split-ring resonator 200.

If a microwave AC power is applied at both ends of the signal line 120, the time-varying electromagnetic field is generated.

The split-ring resonator 200 is positioned to be spaced apart from the center of the signal line 120 and formed of two circular or rectangular signal lines 1220 and 1240, in which one side of each signal line is open, and the opened positions of the signal lines 1220 and 1240 are not overlapped with each other. In addition, the two circular or rectangular signal lines 1220 and 1240 are formed as an inner circular or rectangular signal line 220 and an outer circular or rectangular signal line 240. Here, although it is described as two circular or rectangular signal lines 1220 and 1240, the present invention is not limited thereto, but two or more signal lines may be formed in a variety of shapes such as a triangle, an oval, a diamond and the like, in addition to the circular or rectangular shape.

The circular or rectangular signal lines 1220 and 1240 of the split-ring resonator 200 may be formed of gold, and cys3-protein G is immobilized an the gold surface. This immobilization step fixes an antibody on the gold surface, and in the case of protein G, it is bound to the Fc part of the antibody in order to enhance efficiency of the antibody immobilization.

The split-ring resonator 200 is formed to generate a resonance by generating an induced electromagnetic force which is generated when a time-varying electromagnetic filed generated by the signal line 120 enters into the split-ring resonator 200.

That is, the present invention proposes a resonant device for detecting cortisol, and this device is formed to generate a resonant phenomenon at specific frequency by positioning the split-ring resonator (SRR) on the lose of the microstrip transmission line.

The signal line 120, i.e., the microstrip transmission line (the other parts excluding the split-ring resonator 200), is generally formed as signal line (metal)/dielectric layer/ground layer (metal) as shown in FIG. 1 and generates a time-varying electromagnetic field if AC current flows through the signal line by an AC voltage applied from a microwave power supply having a high frequency. If such a time-varying electromagnetic field enters into the split-ring resonator 200 at an angle almost perpendicular to the surface of the split-ring resonator 200, an induced electromagnetic force is generated by the Faraday's law, and a resonance occurs by a circular current formed in the shape of the device. Particularly, in the present invention, surface current intensity is strengthened by inserting a signal line having relatively high impedance into a signal line section matched at 50 ohm. Since such a form may increase the strength of the time-varying electromagnetic field entering into the split-ring resonator 200, resonant characteristics may be improved as a result.

The process of fabricating a biosensor for measuring stress according to the present invention is as described below

(a) A dielectric substrate, both surfaces of which are coated with a copper thin film, is thinly spin-coated with photoresist and exposed to ultraviolet rays through a mask.

(b) After soaking the substrate in a developer, the loosened photosensitive polymer is dissolved.

(c) Next, only copper in the open photoresist window is etched by soaking the substrate, i.e., a printed circuit board (PCB), in an etchant, and residual photoresist is completely removed using acetone.

(d) The substrate is thinly coated with gold in order to detect cortisol binding, and a thin film (4 um) of nickel is used as an intermediate binding layer between gold and copper.

(e) Finally, the entire area of the resonant device is coated, excluding both ends of the electronic device for measurement and the resonator area for detecting the cortisol.

FIG. 2 is a view showing a partially enlarged split-ring resonator 200 as an example of an actually fabricated biosensor of the present invention.

Here, the split-ring resonator 200 for detecting cortisol is provided with an inner rectangular signal line, and an outer rectangular signal line, and opened positions of the respective rectangular (square) signal lines are not overlapped with each other. Here, the dimension of the fabricated split ting resonator 200 is such that the width a of the open portion and the width w of the line of the rectangle are approximately 0.2 mm respectively, and the distance d between the inner rectangular signal line and the outer rectangular signal line and the distance g between the high impedance line 140 and the split-ring resonator 200 are approximately 0.1 mm respectively, and the length a of one side of the outer rectangle is approximately 0.9 mm, and the size of the entire electronic device including the split-ring resonator 200 and the signal line 120 is 20×10 mm².

The millimeter level PCB process as described above is a most general technique for fabricating a microwave device, and details thereof will be omitted in the present invention. The method of fabricating a biosensor of the present invention is a further economical and simple fabricating technique from the viewpoint of cost and time required for fabrication, compared with a MEMS process for miniaturization and lightweightness.

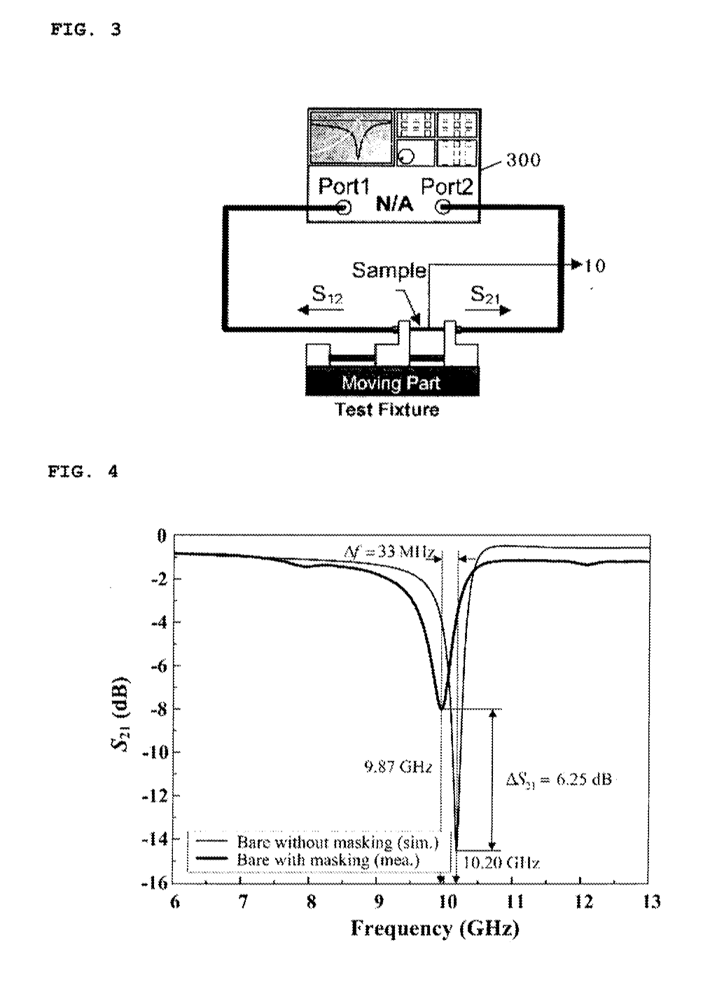

FIG. 3 is a view illustrating a method of measuring cortisol using a biosensor (a cortisol detection sensor) of the present invention.

A cortisol measurement apparatus for measuring cortisol from a sample of a biosensor 10 of the present invention includes a network analyzer (N/A) 300 and the biosensor (a cortisol detection sensor) 10.

If a microwave AC voltage, is applied to the signal line 120 of the biosensor 10, a time-varying electromagnetic field is generated since AC current flows through the signal line 120. Since the time-varying electromagnetic field enters into the split-ring resonator 200 at an angle almost perpendicular to the surface of the split-ring resonator 200, an induced electromagnetic force is generated by the Faraday's law, and thus resonance is occurred by a circular current formed in the shape of the device.

The network analyzer 300 is a microwave measurement system, which detects scattering parameters (S-parameters) and a resonant frequency.

That is, in order to measure a sample using the blosensor 10 of the present invention, the scattering parameters (S-parameters) are measured after a text fixture system connected to the vector network analyzer (VNA), i.e., a microwave measurement system, is precisely calibrated using a standard 2-port line-reflect-match (LRM) calibration method. In the network analyzer having input and output ports, parameter S₂₁(=S₁₂) may be defined as a mathematical expression shown below.

$$[ Mathematical expression 1 ]$$

$${S}_{21} ( = {S}_{12} ) = 20 log ( \frac{{V}_{2}^{-}}{{V}_{1}^{+}} ) ( dB )$$

Here, S₂₁ denotes a ratio of an output voltage wave (V₂⁻) to an input voltage wave (V₁⁺).

In addition, the resonant frequency is defined as shown in mathematical expression 2. Here, LC and C denote inductance and capacitance components, respectively.

fᵣ½π\sqrt{LC}) [Mathematical, expression 2]

FIG. 4 is a graph comparing S_{<}resonant characteristic of a sample detected by a biosensor of the present invention with a result of a simulation.

FIG. 4 is a view showing comparison of S₂₁ resonant characteristic of a sample fabricated in the present invention with a result of a simulation, which shows resonant frequency characteristics of 9.87 MHz and 10,20 MHz, respectively. The resonant characteristic of the sample is such that the resonant frequency is lowered as much as Δf=33 MHz compared with a resonant characteristic simulated without a protection layer and, at the same time, and the signal transmission characteristic is increased as much as ΔS₂₁=6.25 dB. In addition, the quality factor (Q-factor) expressing frequency selectivity and loss characteristic as a resonant device is defined as shown below in mathematical expression 3.

Q=fᵣ/Δf_{3 dB} [Mathematical, expression 3]

Here, fᵣ denotes a resonant frequency, and Δf_{3 db} denotes a frequency bandwidth corresponding to the magnitude, of: 3 dB left and right from the minimum point of S₂₁ resonant frequency. Q value of an ideal device simulated from the aspect of Q characteristic is approximately 50, and Q value actually fabricated sample is approximately 30. This shows resonant characteristic having a further lower Q value since the loss is slightly increased due to the protection layer.

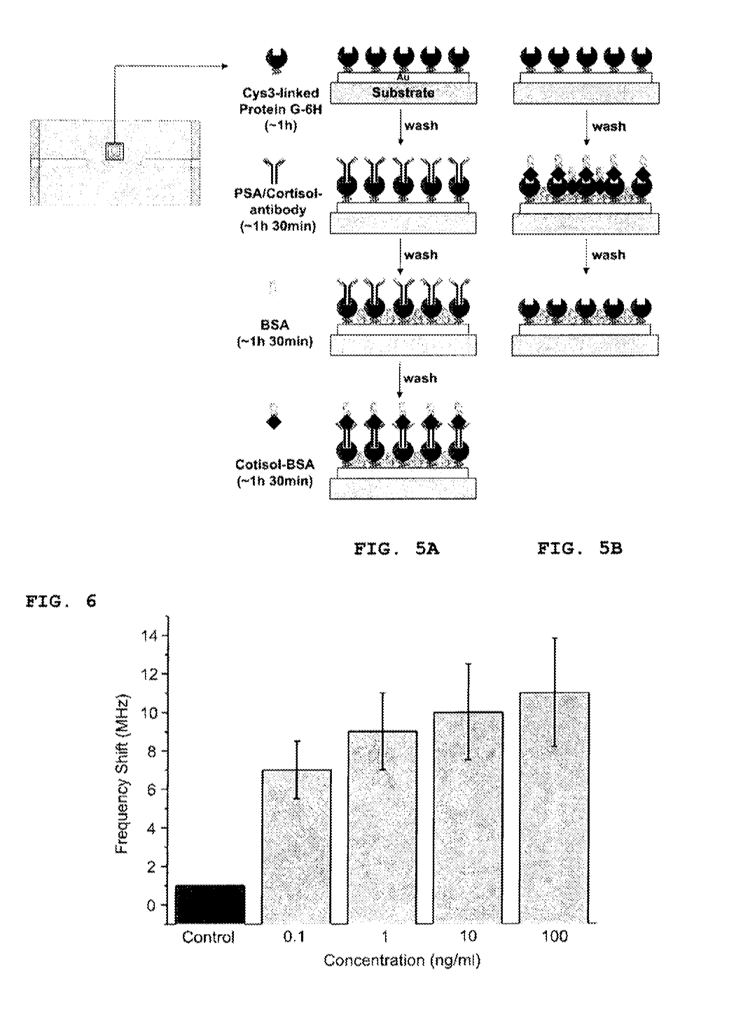

FIGS. 5A and 5B are views illustrating a sensor surface treatment process for measuring cortisol according to an embodiment of the present invention. FIG. 5A shows a sensor surface treatment process for measuring cortisol by a biosensor provided with a split-ring resonator 200 proposed in the present invention, and FIG. 5B shows a sensor surface treatment process for a control group experiment.

Referring to FIG. 5A, in order for a biosensor provided with a split-ring resonator 200 proposed in the present invention to have a functionality for measuring cortisol, the following steps are required.

(i) First, cys3-protein G is immobilized on the gold surface of the split-ring resonator 200 of the biosensor. This immobilization step fixes an antibody on the gold surface, and in the case of protein G, it is bound to the is part of the antibody in order to enhance efficiency of antibody immobilization.

(ii) Next, after preparing phosphate buffered saline (PBS, ph 7.4) having a concentration of 10 ug/ml, the gold surface of the biosensor is responded for an hour, and then a cortisol antibody having a concentration of 500 ng/ml is treated, and the gold surface of the biosensor is responded for one and a half hours.

(iii) Then, non-specific: responses are minimized by treating the gold surface with bovin serum albumin (BSA) having a concentration of 1 mg/ml. The response is continued about an hour, and then cortisol antigens bound to BSA of 100 ng/ml, 10 ng/ml, 1 ng/ml and 100 pg/ml (cortisol-BSA) are responded for one and a half hours, respectively. The amount of sample treated in each step is 10 ul, as much as to be bound to the gold surface of the device, and the initial temperature and humidity condition is maintained to provide an environment for consistently generating a response. When proceeding to a next step, the sample is washed and dried with a pure PBS solution three times or more.

The sensor surface treatment process for measuring cortisol is summarized in FIGS. 5A and 5B, and FIG. 5B shows is sensor surface treatment process for a control group experiment In the case of the control group, cys3-protein G is immobilized, and BSA is directly treated on the gold surface without a cortisol antibody, and then the cys3-protein G is bound to the cortisol-BSA antigen.

The measurement has been performed three times for the same sample using the microwave, measurement system of FIG. 2. That is, a sample in which a biomaterial is not treated at all, a sample in which a cortisol antibody and BSA are treated on cys-3-protein G, and a sample in which BSA is treated on the cortisol are measured, respectively. Each time of the measurements, the microwave measurement system is precisely re-calibrated, and then the measurement is performed for a short period of time (for less than one minute) after completely drying the sample. According to a result of measuring the samples, the characteristic according to binding of a biomaterial :is almost unchanged or slightly changed, whereas the frequency is sensitive to binding and concentration of a biomaterial and shows notable changes.

As a result, in the case of samples in which a cortisol antibody and BSA are treated on cys-3-protein G, the frequency (change) Δf=≅±3 MHz, which is comparatively a large change, and in the case of the four different cortisol-BSA antigen concentrations of 100 ng/ml, 10 ml, 1 ng/ml and 100 pg/ml, frequencies are changed as much as Δf=11±0.7 MHz, Δf=10±1 MHz, Δf=9±1.3 MHz and Δf=7±1.4 MHz, respectively. In the case of the control group, a frequency change of Δf=1±0.5 is shown, and this confirms that occurrence of the antigen-antibody response of the cortisol is almost negligible.

FIG. 6 is a view showing frequency changes according to cortisol-BAS concentration in an experiment using a biosensor of the present invention.

Finally, frequency changes according to cortisol-BAS concentration is shown in FIG. 6. Meanwhile, one thing to be noted in measuring a sample is that after a biomaterial is bound to the sample, the sample is measured after washing the sample with a pure PBS solution and completely removing moisture. This is since that moisture having a high dielectric constant value may change resonant characteristics due to the characteristics of a microwave device.

Although the cortisol material used in this experiment may be regarded as a nano-sized particle having an electric charge, components of capacitance, inductance and resistance, which are electrical characteristics of the resonator itself, are changed simultaneously as the binding effect or effective cortisol increases at a relatively high concentration (up to 100 ng/ml). Particularly, it may be considered that the frequency change is most greatly affected by the capacitance component among the three electrical components. This is because that great frequency change may be occurred according to the change in the capacitance since the effective cortisol is electrically a thin dielectric membrane of a nano-size. The principle, is that a sensor based on changes in the electrical characteristics may be equally applied to studies on biotin-streptavidin or DNA hybridization detection, which is a type of an antigen-antibody response, as well detection by cell. Since such a cortisol binding effect is lowered as the concentration becomes relatively low, the frequency change, will be lowered further more.

In FIGS. 5A and 5B, stress has been most frequently studied until today among changes in a human body, which are almost linear, according to concentration of an antigen bound to cortisol-BSA, and the cortisol which is a measurement index thereof is originally a steroid hormone, related to a variety of diseases including blood pressure and blood sugar control, carbohydrate metabolism and inflammation. However, as it is revealed recently that there is a close relation between post-traumatic stress disorder (PTSD) and distribution of cortisol in saliva, blood and urine, the cortisol measurement is spotlighted in the medical and psychological society. Furthermore, since it also seems to have a certain relationship with a real communication paradigm of an individual, instantaneous and convenient cortisol measurement needs to he treated significantly from the context of social interaction.

The present invention proposes a resonant device having a structure that can generate a resonant phenomenon at a specific frequency by positioning a split-ring resonator (SRR) on the base of a microstrip transmission line. Linear frequency changes between. 7 MHz and 11 MHz have been measured according to cortisol concentration between 0.1 ng/ml and 100 ng/ml in a method of immobilizing an antibody for recognizing the cortisol on the resonant device, measuring a resonant frequency after capturing the cortisol, and confirming existence of cortisol by comparing the measured resonant frequency with a resonant frequency measured when the cortisol does not exist.

The range of a detectable minimum frequency in the present invention has a resolution of approximately 1 to 1.5 MHz. The frequency change according to the cortisol concentration may he applied to a wireless terminal system in the future.

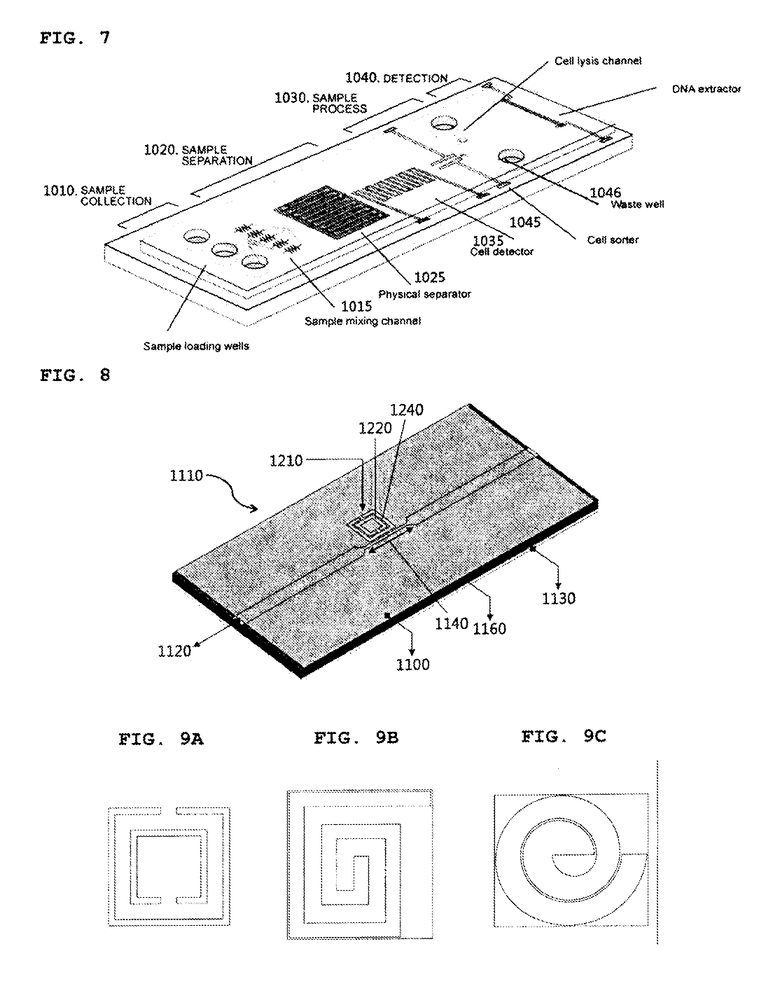

Meanwhile, a second embodiment (embodiment 2-1, embodiment 2-2 and embodiment 2-3) of the present invention will be described hereinafter with reference to FIGS. 7 to 16.

FIG. 7 is a mimetic view showing the configuration of a biosensor for diagnosing emotion according to a second embodiment of the present invention, and the biosensor includes a biosample collection unit 1010, an emotion index separation and purification unit 1020, a measurement unit 1030 and a result output unit 1040.

The biosample collection unit 1010 has three injection boles, and one of them is a sample injection hole. The other two injection holes may be a sheath solution injection hole and a reactive enzyme injection hole.

The emotion index separation and purification unit 1020 includes a sample mixing unit 1015, an emotion index separation unit 1025 and an emotion index sensing unit 1035.

The sample mixing unit 1015 mixes a sample injected through the sample injection hole with a reactive enzyme injected through the reactive enzyme injection hole. Here, a sheath solution may be injected through the sheath solution injection hole in order to appropriately push the sample injected through the sample injection hole and the reactive enzyme solution injected through the reactive enzyme injection hole into the sample mixing unit 1015 so that they may be properly mixed. At this point, the reactive enzyme is mixed with the sample, and the sample responds to the reactive enzyme, and, as a result, an emotion index is included in the solution in the sample mixing unit 1015.

The emotion index separator 1025 separates an emotion index from the solution of the sample mixing unit 1015.

The emotion index sensing unit 1035 senses the emotion index separated by the emotion index separator 1025. For example, an emotion index is sensed in a dielectrophoresis method or the like and output along a micro fluid passage.

The measurement unit 1030 detects an emotion index from a sensor (or a filter) among the samples flowing from an end of the emotion index sensing unit 1035 along a micro fluid passage and discharges impurities through an impurity outlet 46.

The result output unit 1040 calculates concentration of an emotion index based on intensity of fluorescence, impedance or the like.

FIG. 8 is a mimetic view showing the configuration of a biosensor according to another embodiment of the present invention. That is, FIG. 8 is a mimetic view showing the configuration of a biosensor for measuring stress.

A biosensor 1110 of the present invention is configured to detect cortisol and includes a ground layer 1130, a dielectric layer 1160 and a masking layer 1100.

The ground layer 1130 is formed of a metal at the bottom. The metal is a conductive metal.

The dielectric layer 1160 is formed on the ground layer 1130.

The masking layer 1100 may be a power source layer having a small pattern and is formed on the dielectric layer. The masking layer 1100 includes a signal line 1120 and a ring resonator (SRR) 1200.

The signal line 1120 is a microstrip transmission line crossing the center of the masking layer 1100, and a portion of the signal line 1120 formed near the ring resonator 1200 is a high impedance line 1140.

The high impedance line 1140 is a portion of the signal line 1120 formed near the ring resonator 1200 to have a with smaller than that of the other portion of the signal line 1120 that is not close to the ring resonator 1200. The high impedance line 1140 strengthens surface current intensity by inserting a signal line having relatively high impedance into a signal line section matched at 50 ohm, and such a form may increase the strength of the time-varying electromagnetic field entering into the ring resonator 1200.

If a microwave AC power is applied at both ends of the signal line 1120, the time-varying electromagnetic field is generated.

A split-ring resonator (SRR) is used as the ring resonator 1200 in FIG. 8, and the ring resonator 1200 is positioned to be spaced apart from the center of the signal line 1120 and formed of two circular or rectangular signal lines 1220 and 1240, in which one side of each signal line is open, and the opened positions of the signal lines 11220 and 1240 are not overlapped with each other. In addition, the two circular or rectangular signal lines 1220 and 1240 are formed as an inner circular or rectangular signal line 1220 and an outer circular or rectangular signal line 1240. Here, although it is described as two circular or rectangular signal lines 1220 and 1240, the present invention is not limited thereto, but two or more signal lines may be formed in a variety of shapes such as a triangle, an oval, a diamond and the like, in addition to a circle and a rectangle.

The circular or rectangular signal lines 1220 and 1240 of the ring resonator 1200 may be formed of gold, and cys3-protein G is immobilized on the gold surface. This immobilization step fixes an antibody on the gold surface, and in the case, of protein G, it is bound to the Fc part of the antibody in order to enhance efficiency of antibody immobilization.

The ring resonator 1200 is formed to generate a resonance by generating an induced electromagnetic force when a time-varying electromagnetic filed generated by the signal line 1120 enters into the ring resonator 1200.

That is, the present invention proposes a resonant device for detecting cortisol, and this device is formed to generate a resonant phenomenon at a specific frequency by positioning the ring resonator on the base of the microstrip transmission line.

The signal line 1120, i.e., the microstrip transmission line (the other part excluding the ring resonator 1200), is generally formed as signal line (metal)/dielectric layer/ground layer (metal) as shown in FIG. 7 and generates a time-varying electromagnetic field if AC current flows through the signal line by an AC voltage applied from a microwave power supply having high frequency if such a time-varying electromagnetic field enters into the ring resonator 1200 at an angle almost perpendicular to the surface of the ring resonator 1200, an induced electromagnetic force is generated by the Faraday's law, and a resonance occurs by a circular current formed in the shape of the device. Particularly, in the present invention, surface current intensity is strengthened by inserting a signal line having relatively high impedance into a signal line section matched at 50 ohm. Since such a form may increase the strength of the time-varying electromagnetic field entering into the ring resonator 1200, resonant characteristics may be improved as a result.

The process of fabricating a biosensor for measuring stress of FIG. 8 is as described below.

(a) A dielectric substrate, both surfaces of which are coated with a copper thin film, is thinly spin-coated with photoresist and exposed to ultraviolet rays through a mask.

(b) After soaking the substrate in a developer, the loosened photosensitive polymer is dissolved.

(c) Next, only copper in the open photoresist window is etched by soaking the substrate, i.e., a printed circuit board (PCB), in an etchant, and residual photoresist is completely removed using acetone.

(d) The substrate is thinly coated with gold in order to detect cortisol binding, and a thin film (4 um) of nickel is used as an intermediate binding layer between gold and copper.

(e) Finally, the entire area of the resonant device is coated, excluding both ends the electronic device for measurement and the resonator area for detecting the cortisol.

FIGS. 9A to 9C are views showing examples of a resonator that can be used as the ring resonator of FIG. 8.

FIG. 9A is a view showing the split-ring resonator used in FIG. 8.

FIG. 9B is a view showing a circular spiral resonator having a shape of a whirl.

FIG. 9C is a view showing a circular spiral resonator in which the distance between signal lines is short.

Although a split-ring resonator, a spiral resonator and the like are described above as a resonator applicable as the ring resonator 1200 of the present, it is noted in advance that a variety of resonators can be applied if the present invention is not limited thereby.

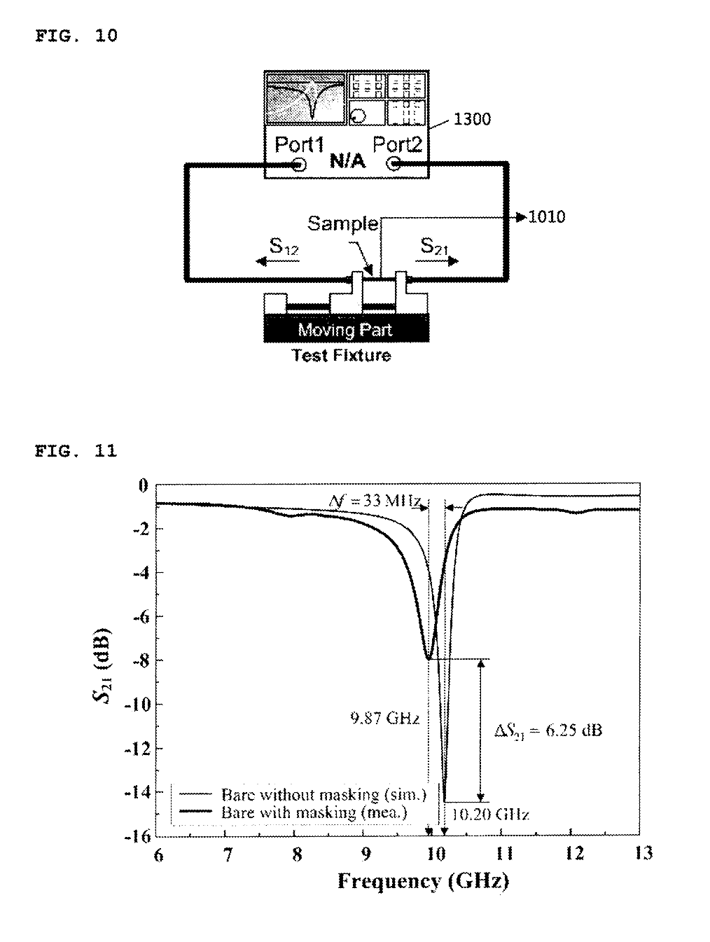

FIG. 10 is a view illustrating a method of measuring cortisol using the biosensor (a cortisol detection sensor) of FIG. 8.

A cortisol measurement sensor for measuring cortisol from a sample of the biosensor 1110 of FIG. 10 includes a network analyzer (N/A) 1300 and the biosensor (cortisol detection sensor) 1010.

If a microwave AC voltage is applied to the signal line 1120 of the biosensor 1110, a time-varying electromagnetic field is generated since AC current flows through the signal line 1120. Since the time-varying electromagnetic field enters into a split-ring resonator 1200 at an angle almost perpendicular to the surface of the split-ring resonator 1200, an induced electromagnetic force is generated by the Faraday's law, and thus resonance is occurred by a circular current formed in the shape of the device.

The network analyzer 1300 is a microwave measurement system, which detects scattering parameters (S-parameters) and a resonant frequency.

That is, in order to measure a sample using the biosensor 1110 of the present invention, the scattering parameters (S-parameters) are measured after a text fixture system connected to the network analyzer (N/A), i.e., a microwave measurement system, is precisely calibrated using a standard 2-port line-reflect-match (LRM) calibration method. In the network analyzer having input and output ports, parameter S₂₁(=S₁₂) may be defined as a mathematical expression shown below.

$$[ Mathematical expression 4 ]$$

$${S}_{21} ( = {S}_{12} ) = 20 log ( \frac{{V}_{2}^{-}}{{V}_{1}^{+}} ) ( dB )$$

Here, S₂₁ denotes a ratio of an output voltage wave (V₂⁻) to an input voltage wave (V₁⁺).

fᵣ½π\sqrt{LC}) [Mathematical expression 3]

In addition, the resonant frequency is defined as shown in mathematical expression 2. Here, LC and C denote inductance and capacitance components, respectively.

FIG. 11 is a graph comparing S₂₁ resonant characteristic of a sample detected by a blosensor of FIG. 8 with a result of a simulation.

FIG. 11 is a view showing comparison of S₂₁ resonant characteristic of a sample fabricated in the present invention with a result of a simulation, which shows resonant frequency characteristics 9.87 MHz and 10.20 MHz, respectively. The resonant characteristic of the sample is such that the resonant frequency is lowered as much as Δf=33 MHz compared with a resonant characteristic simulated without a protection layer and, at the same time, and the signal transmission characteristic is increased much as ΔS₂₁=6.25 dB. In addition, the quality factor (Q-factor) expressing frequency selectivity and loss characteristic as a resonant device is defined as shown below in mathematical expression 6.

Q=fᵣ/Δf_{3 db} [Mathematical expression 3]

Here, fᵣ denotes a resonant frequency, and Δf_{3 db} denotes a frequency bandwidth corresponding to the magnitude of ±3 dB left and right from the minimum point of S₂₁ resonant frequency. Q value of an ideal device simulated from the aspect of Q characteristic is approximately 50, and Q value of an actually fabricated sample is approximately 30. This shows a resonant characteristic having a further lower Q value since the loss is slightly increased due to the protection layer.

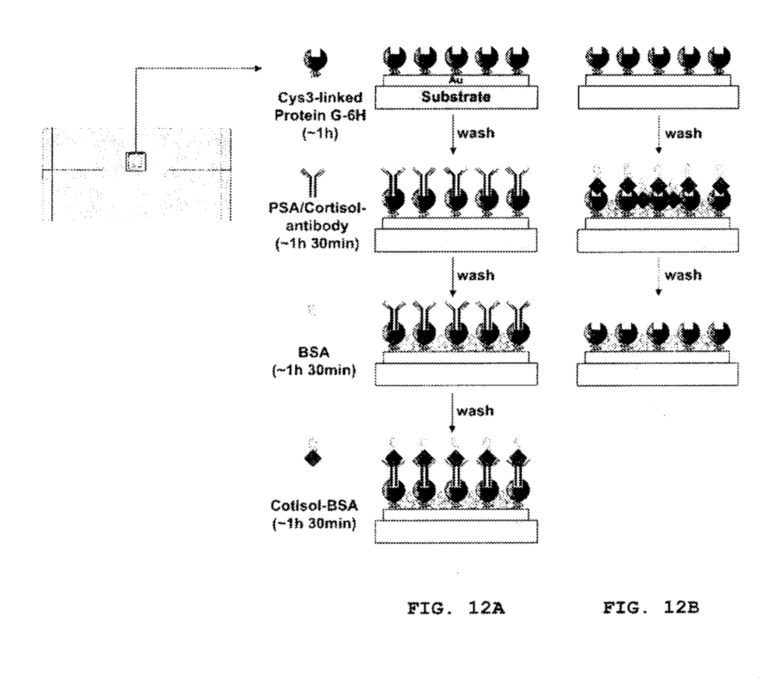

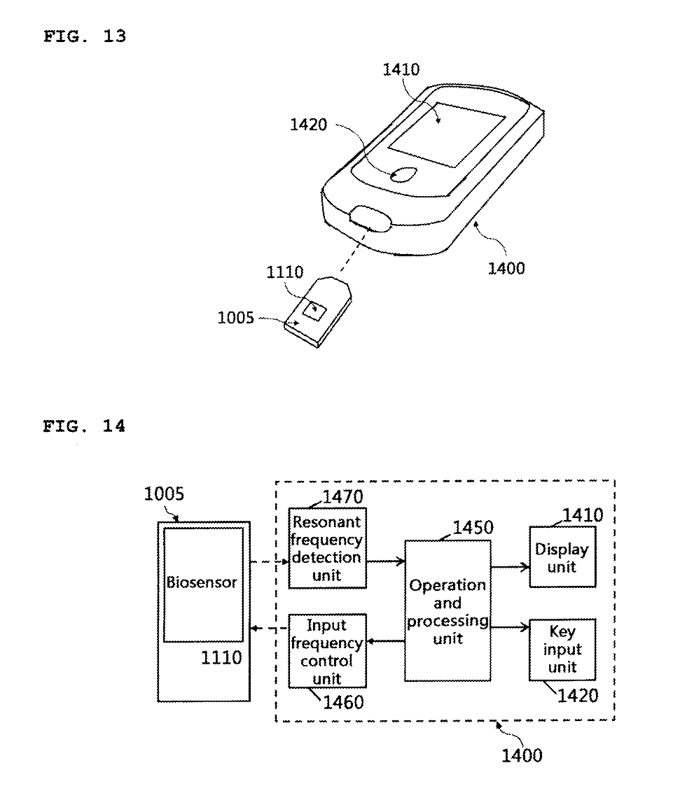

FIGS. 12A and 12B are views illustrating a sensor surface treatment process for measuring cortisol at the biosensor of FIG. 8. FIG. 12A shows a sensor surface treatment process for measuring cortisol by a biosensor provided with a split-ring resonator 200 proposed in the present invention, and FIG. 12B shows a sensor surface treatment process for a control group experiment.

Referring to FIG. 12A, in order for a biosensor provided with a ring resonator 1200 proposed in the present invention to have a functionality for measuring cortisol, the following steps are required.

(i) First, cys3-protein G is immobilized on the gob surface of the split-ring resonator 1200 of the biosensor. This immobilization: step fixes an antibody on the gold surface, and in the case of protein G, it is bound to the Fc part of the antibody in order to enhance efficiency of antibody immobilization.

(ii) Next, after preparing phosphate buffered saline PBS, pH 74) having a concentration of 10 ug/ml, the gold surface of the biosensor is responded for an hour, and then a cortisol antibody having a concentration of 500 ng/ml is treated, and the gold surface of the biosensor is responded for one and a half hours.

(iii) Then, non-specific responses are minimized by treating the gold surface with bovin serum albumin (BSA) having a concentration of 1 mg/ml. The response is continued about an hour, and then cortisol antigens bound to BSA of 100 ng/ml, 10 ng/ml, 1 ng/ml and 100 pg/ml (cortisol-BSA) are responded for one and a half hours, respectively. The amount of sample treated in each step is 10 ul, as much as to be bound to the gold surface of the device, and the initial temperature and humidity condition is maintained to provide an environment for consistently generating a response. When proceeding to a next step, the sample is washed and dried with a pure PBS solution three times or more.

The sensor surface treatment process for measuring cortisol is summarized in FIGS. 12A and 12B, and FIG. 12B shows a sensor surface treatment process for a control group experiment. In the case of the control group, cys3-protein G is immobilized, and BSA is directly treated on the gold surface without a cortisol antibody, and then the cys3-protein G is bound to the cortisol-BSA antigen.

The measurement has been performed three times for the same sample using the microwave measurement system of FIG. 10. That is, a sample in which a biomaterial is not treated at all, a sample in which a cortisol antibody and BSA are treated on cys-3-protein G, and a sample in which BSA is treated on the cortisol are measured, respectively. Each time of the measurements, the microwave measurement system is precisely re-calibrated, and then the measurement is performed for a short period of time (for less than one minute) after completely drying the sample. According to a result of measuring the samples, the Q characteristic according to binding of a biomaterial is almost unchanged or slightly changed, whereas the frequency is sensitive to binding and concentration of a biomaterial and shows notable changes.

As result, in the case of samples in which a cortisol antibody and BSA are treated on cys-3-protein G, the frequency (change) is Δf=25±3 MHz, which is comparatively large change, and in the case of the four different cortisol-BSA antigen concentrations of 160 ng/ml, 10 ng/ml, 1 ng/ml and 100 pg/ml, frequencies are changed as much as Δf=11±0.7 MHz, Δf=10±1 MHz, Δf=9±1.3 MHz and Δf=7±1.4 MHz, respectively. In the case of the control group, a frequency change of Δf=1±0.5 is shown, and this confirms that occurrence of the antigen-antibody response of the cortisol is almost negligible.

In FIG. 8, proposed is a resonant device having a structure that can generate a resonant phenomenon at a specific frequency by positioning a split-ring resonator (SRR) on the base of a microstrip transmission line. Linear frequency changes between 7 MHz and 11 MHz have been measured according to cortisol concentration between 0.1 mg/ml and 100 ng/ml in a method of immobilizing an antibody for recognizing the cortisol on the resonant device, measuring a resonant frequency after capturing the cortisol, and confirming existence of cortisol by comparing the measured resonant frequency with a resonant frequency measured when the cortisol does not exist.

The range of a detectable minimum frequency in the present invention has a resolution of approximately 1 to 1.5 MHz. The frequency change according to the cortisol concentration may be applied to a wireless terminal system in the future.

FIG. 13 is a view showing an example of an emotion-on-a-chip and an emotion diagnosis apparatus according to a second embodiment of the present invention, and FIG. 14 is a block diagram schematically showing the configuration of the emotion diagnosis apparatus of FIG. 13.

In FIG. 13, the emotion-on-a-chip 1005 is an emotion diagnosis chic on which the biosensor 1110 of FIG. 8 is mounted, and the emotion-on-a-chip 1005 filled with a body fluid is mounted on the emotion diagnosis apparatus 1400.

If the emotion-on-a-chip 1005 is mounted and the start button in a key input unit 1420 of the emotion diagnosis apparatus 1400 is pressed, the emotion-on-a-chip 1005 detects an emotion level, i.e., a stress level or a stress index, from the emotion-on-a-chip 1005 (>> the body fluid ?) and outputs the emotion level to a display unit 1410.

The emotion diagnosis apparatus 1400 of FIG. 14 includes a display unit 1410, a key input unit 1420, an operation and processing unit 1450, a resonant frequency detection unit 1470 and an input frequency control unit 1460. Here, the resonant frequency detection unit 1470 and the input frequency control unit 1460 may be referred to as a signal detection unit.

Although the biosensor and the signal detection unit are described in FIGS. 13 and 14 based on FIG. 8, it is noted that this is not to limit the present invention. A variety of biosensors including the biosensor of FIG. 7 may be mounted as the biosensor 1110 of FIGS. 13 and 14, and although the signal detection unit is described to including the resonant frequency detection unit 1470 and the input frequency control unit 1460 based on the biosensor of FIG. 8, other various signal detection units may be mounted.

The display unit 1410 receives the stress index output from the operation and processing unit 1450 and outputs the stress index as a graph or a text. In some cases, the display unit 1410 is provided with a LED or the like in order to output the stress index as a light of a different color depending on the stress level.

The key input unit 1420 is provided with a start button and a stop button and may be further provided with a sex and age setting mode of a user depending on situations.

The operation and processing unit 1450 receives output data of the key input unit 1420, receives an output signal, stress detection signal, of the signal detection unit, calculates a stress level (a stress index) and determines and outputs whether or not the calculated stress level is within a normal range.

That is, the operation and processing unit 1450 converts the stress detection signal of the signal detection unit into a stress index based on a predetermined stress unit value and outputs the stress index onto the display unit 1410, and compares the stress index with a reference range based on a sex and age and outputs result thereof. The operation and processing it 1450 may be a microprocessor or a microcontroller.

The signal detection unit is a means for detecting a stress signal from the biosensor 1110 and includes a resonant frequency detection unit 1470 and an input frequency control unit 1460 in the case of FIG. 8.

The input frequency control unit 1460 is a means for inputting a power (voltage or current) having a predetermined frequency in order to detect a resonant frequency using the biosensor 1110 of FIG. 8.

The resonant frequency detection unit 1470 is a means for detecting a frequency when a resonance occurs. The frequency may be detected by a current or voltage detection unit, which is a certain part of the biosensor 1110.

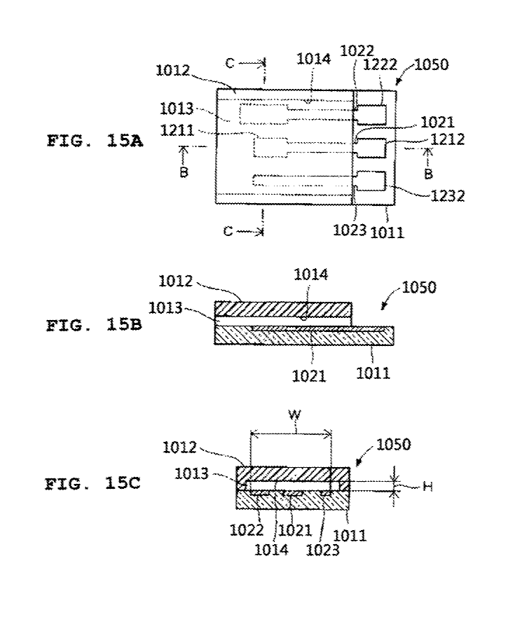

FIGS. 15A to 15C are views showing a biochip of Japanese Laid-open Patent No. 2007-17169, and the biochip 1110 of FIG. 13 may be used as the biochip of FIGS. 15A to 15C, and in this case, the signal detection unit is configured as a current detection unit.

FIGS. 15A to 15C relate to a biosensor, i.e., a component measurement apparatus, of a simple structure for detecting concentration of endorphin, which measures concentration of an antigen with high precision in a speedy way without the need of a large facility, and an antibody is immobilized at a working electrode formed on the substrate 1011. In addition, a counter electrode 1022 is on the substrate 1011 in opposition to the working electrode 1021. An antibody labeled with an enzyme is bound to an antigen which is bound to the antibody immobilized on the working electrode 1021. Since the working electrode 1021 and the counter electrode 1022 are exposed to a flat reactor 1013, response speeds of the antibody, the antigen and the labeled antibody immobilized on the working electrode 1021 are improved, and thus concentration of the antigen is measured in a speedy way. In addition, an oxidation and reduction reaction is occurred by the enzyme of the labeled antibody around the working electrode 1021 where the antibody is immobilized. Therefore, since an oxidation and reduction material efficiently receives electrons from the working electrode 1021, sensitivity of detecting the current flowing between the working electrode 1021 and the counter electrode 1022 is improved.

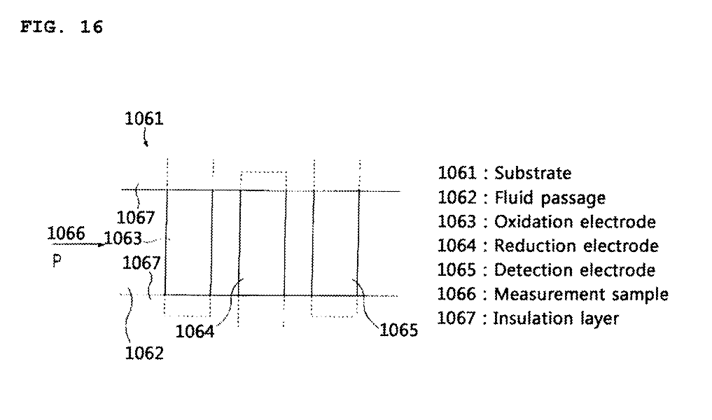

FIG. 16 is a view showing a biochip of Japanese Laid-open Patent No. 2007-163440, and the biochip 1110 of FIG. 13 may be used as the biochip of FIG. 16, and in this case, the signal detection unit is configured as a current detection unit.

This is related to a catecholamine sensor which enables continuously monitoring of the catecholamine concentration of a biosample such as blood or the like by reducing the effect of a measurement interference material, and the catecholamine sensor related to an embodiment of the present invention detects the catecholamine concentration by flowing a measurement sample 1066 from the upper stream to the down stream of a fluid passage 1062. The catecholamine sensor includes an oxidation electrode 1063 for oxidizing the catecholamine and the measurement interference material contained in the measurement sample 66 formed in the fluid passage 1062, a reduction electrode 1064 for reducing the catecholamine, formed at a further down stream from the oxidation electrode 1063 in the fluid passage 1062, and a detention electrode 1065 for detecting the catecholamine, formed at a further down stream from the reduction electrode 1064 in the fluid passage 1062.

The EOC used in the present invention is configured, of a biomarker for measuring emotion, an electrode for obtaining a signal, a converter for converting the signal and a part for showing a result of the measurement.

According to the biosensor and the measurement method thereof of the present invention, cortisol in saliva can he easily and rapidly measured by immobilizing an antibody for measuring the cortisol in saliva on a miniaturized microwave resonant device and reading an electrical signal which is generated when the antibody is bound to the cortisol.

According to the biosensor and the measurement method thereof of the present invention, there is provided a structure capable of generating a resonant phenomenon at a specific frequency by positioning a split-ring resonator on the base of a microstrip transmission line. A time-varying electromagnetic field is generated by applying a microwave AC voltage at both ends of a microstrip signal line, and an induced electromagnetic force is generated when the time-varying electromagnetic field enters into the split-ring resonator, so that a resonance occurs.

According to the biosensor and the measurement method thereof of the present invention, existence of cortisol is confirmed by immobilizing an antibody for recognizing the cortisol on a resonant device, measuring a resonant frequency after capturing the cortisol, and comparing the measured resonant frequency with a resonant frequency measured when the cortisol does not exist.

Accordingly, the present invention is appropriate for point of care testing (FOOT) since, in measuring cortisol, the cortisol can be detected rapidly in real-time without the need of a label, using a portable apparatus of a low price.

Particularly, in an experiment using a biosensor of the present invention, almost linear frequency response characteristics (11, 10, 9 and 7 MHz) are shown according to changes in concentration of cortisol (100, 10, 1 and 0.1 ng/ml) which is bound on the surface of the device, and the present invention is advantageous in that even a small amount of cortisol, as small as 100 pg/ml, can he easily detected within a short time almost close to real-time, and in addition, labeling is not required. A cortisol emotion index sensor based on changes of frequency which is dependent on the concentration of cortisol has possibility and applicability for being applied to a wireless terminal system.

According to the emotion-on-a-chip of the present invention and the measurement method thereof, various emotion indexes can be measured on the chip by measuring an emotion index target material. (a metabolite, a biogenic hormone or the like) such as catecholamine, cortisol or the like in real-time from a body fluid such as blood, salvia, urine, sweat or the like.

The present invention is advantageous in that a positive state may be induced or maintained by recognizing an abnormal change in an individual occurred in response to an external stimulus. In addition, the abnormal change or the positive state of emotion can be analyzed in a variety of ways depending on viewpoints.

For example, from the viewpoint of education for young students, if a student who successfully adapts to school life and shows concentrativeness, understandability, satisfaction and the like in learning is in a positive state, an abnormal change may be a result of emotion which hinders such a positive state.

From the medical viewpoint, an abnormal change, may be depression, uneasiness, anger, obsession, hatred or the like which induces a mental disease or hinders a normal life, and a positive state is a state of living a normal life within a society.

Stress which comes from heavy works and competing human relationships may be regarded as an abnormal change, and restoration to a positive state may be induced through resting, exercising and the like by recognizing the stress.

The present invention may examine and measure an emotional state of an individual in a convenient and economical way, and a result of the emotion measurement may be advantageously utilized in a variety of fields.

While the present invention has been described with reference to the particular illustrative embodiments, it is not to be restricted by the embodiments but only by the appended claims. It is to be appreciated that those skilled in the art can change, or modify the embodiments without departing from the scope and spirit of the present invention.

What is claimed is:

1. A cortisol detection sensor comprising:
a ground layer formed of a metal at a bottom;
a dielectric layer formed on the ground layer; and
a masking layer formed on the dielectric layer and provided with a microstrip transmission line and a split-ring resonator.

2. A cortisol detection sensor comprising:
a split-ring resonator positioned on a dielectric layer, having an inner circle, one side of which is open, and an outer circle, the other side of which is open; and
as microstrip transmission line formed on the dielectric layer as a straight signal line installed to be spaced apart from one side of the split-ring resonator.

3. A cortisol detection sensor, wherein a split-ring resonator is positioned at one side of a microstrip transmission line on a dielectric layer, and existence of cortisol is detected by immobilizing an antibody for recognizing the cortisol on the split-ring resonator and measuring a resonant frequency after capturing the cortisol.

4. The sensor according to claim 1, wherein the split-ring resonator is positioned to be spaced apart from a center of the microstrip transmission line, and a width of a portion of the microstrip transmission line formed near the split-ring resonator is smaller than a width of the other portion of the microstrip transmission line that is not close to the split-ring resonator.

5. The sensor according to claim 4, wherein a time-varying electromagnetic field is generated by applying a microwave AC voltage at both ends of the microstrip transmission line, and a resonance is occurred by an induced electromagnetic force which is generated when the time varying electromagnetic field enters into the split-ring resonator.

6. The sensor according to claim 1, wherein the split-ring resonator is formed of an inner pattern, one side of which is open, and an outer pattern positioned outside of the inner pattern, the other side of which is open, and the inner pattern and the outer pattern are formed in any one of a circle, a rectangle, a triangle, an oval and a diamond.

7. A method of fabricating a cortisol detection sensor comprising:
first step of thinly spin-coating a dielectric substrate, both surfaces of which are coated with a copper thin film, with photoresist;
a second step of dissolving a loosened photosensitive polymer layer after soaking the dielectric substrate in a developer;
a third step of forming a printed circuit board (PCB) by printing a circuit in a form of a microstrip transmission line and a split-ring resonator on the dielectric substrate prepared in the second step, etching only copper in an open photoresist window by soaking the PCB in an etchant, and completely removing residual photoresist using acetone; and
a fourth step of thinly coating the dielectric substrate etched in the third step with gold in order to detect cortisol binding.

8. The method according to claim 7, further comprising a fifth step, after the fourth step, of coating the dielectric substrate, except both end points of the microstrip transmission line and the split-ring resonator.

9. A cortisol measurement system comprising:
a cortisol detection sensor including a split-ring resonator positioned at one side of a microstrip transmission line on a dielectric substrate and an antibody for recognizing cortisol immobilized on the split-ring resonator; and
a network analyzer for detecting scattering parameters (S-parameters) and a resonant frequency from the cortisol detection sensor.

10. An emotion diagnosis system comprising:
an emotion-on-a-chip on which a biosensor for detecting an emotion signal including stress is mounted; and
an emotion diagnosis apparatus for converting the emotion signal received from the emotion-on-a-chip into an emotion level, i.e., an emotion index, and outputting the emotion level, wherein the emotion-on-a-chip includes:
a ground layer formed of a metal at a bottom;
a dielectric layer formed on the ground layer; and
a masking layer formed on the dielectric layer and provided with a microstrip transmission line and a ring resonator.

11. An emotion diagnosis system comprising;
an emotion-on-a-chip on which a biosensor for detecting an emotion signal including stress is mounted.; and
an emotion diagnosis apparatus for converting the emotion signal received from the emotion-on-a-chip into an emotion level, i.e., an emotion index, and outputting the emotion level, wherein
the emotion-on-a-chip includes:
a ring resonator positioned on a dielectric layer, having an inner circle, one side of which is open, and an outer circle, the other side of which is open; and
a microstrip transmission line formed on the dielectric layer as a straight signal line installed to be spaced apart from one side of the ring resonator.

12. An emotion diagnosis system comprising:
an emotion-on-a-chip on which a biosensor for detecting an emotion signal including stress is mounted; and
an emotion diagnosis apparatus for converting the emotion signal received from the emotion-on-a chip into an emotion level, i.e., an emotion index, and outputting the emotion level, wherein.
the emotion-on-a-chip includes:
a biosample collection unit having a sample injection hole, a sheath solution injection hole and a reactive enzyme injection hole;
an emotion index separation and purification unit for mixing a sample injected through the sample injection hole with a reactive enzyme injected through the reactive enzyme injection hole in a sample mixing unit, responding the sample with the reactive enzyme, and separating the emotion index from a solution in the sample mixing unit;
a measurement unit for detecting the emotion index by an emotion index detection sensor from the sample which is output from the emotion index separation and purification unit and flows along a micro fluid passage; and
a result output unit for calculating concentration of the emotion index based on intensity of fluorescence and impedance of the emotion index detected by the measurement unit.

13. The system according to claim 10, wherein the ring resonator is positioned to be spaced apart from a center of microstrip transmission line, and a width of a portion of the microstrip transmission line formed near the ring resonator is smaller than a width of the other portion of the microstrip transmission line that is not close to the split-ring resonator.

14. The system according to claim 13, wherein a time-varying electromagnetic field is generated by applying a microwave AC voltage at both ends of the microstrip transmission line, and a resonance is occurred by an induced electromagnetic force which is generated when the time-varying electromagnetic field enters into the split-ring resonator.

15. An emotion diagnosis system comprising:
an emotion-on-a-chip on which a biosensor for detecting an emotion signal including stress is mounted; and
an emotion diagnosis apparatus for converting the emotion signal received from the emotion-on-a-chip into an emotion level, i.e., an emotion index, and outputting the emotion level, wherein
the emotion diagnosis apparatus includes:
a signal detection unit for detecting an electrical signal expressing stress as a stress signal from the biosensor; and
an operation and processing unit formed as a microprocessor, for converting the stress detection signal received from the signal detection unit into a stress index based on a value of a predetermined stress unit, and outputting a result of comparing the stress index with a reference range according to a sex and age.

16. The system according to claim 15, further comprising a display unit for receiving the stress index and the result of the comparison output from the operation and processing unit and outputting them as a graph or a text.

17. The system according to claim 15, wherein the emotion-on-a-chip is formed to detect concentration of cortisol and includes:
a ring resonator positioned on a dielectric layer, having an inner circle, one side of which is open, and an outer circle, the other side of which is open; and
a microstrip transmission line formed on the dielectric layer as a straight signal line installed to be spaced apart from one side of the ring resonator.

18. The system according to claim 15, wherein the emotion-on-a-chip includes:
a biosample collection unit having a sample injection hole, a sheath solution injection hole and a reactive enzyme injection hole;
an emotion index separation and purification unit for mixing a sample injected through the sample injection hole with a reactive enzyme injected through the reactive enzyme injection hole in a sample mixing unit, responding the sample with the reactive enzyme, and separating the emotion index from a solution in the sample mixing unit;
a measurement unit for detecting the emotion index by an emotion index detection sensor from the sample which is output from the emotion index separation and purification unit and flows along a micro fluid passage; and
a result output unit for calculating concentration of the emotion index based on intensity of fluorescence and impedance of the emotion index detected by the measurement unit.

19. The system according to claim 15, wherein the emotion-on-a-chip is formed to detect concentration of endorphin, wherein
a working electrode on which an antibody is immobilized and a counter electrode installed in opposition to the working electrode are formed on the substrate, and
an antibody labeled with an enzyme is bound to an antigen which bound to the antibody immobilized on the working electrode, and the working electrode and the counter electrode are exposed to a reactor.

20. The system according to claim 15, wherein the emotion-on-a-chip includes a catecholamine sensor formed to detect concentration of catecholamine by flowing a measurement sample from an upper stream to a down stream of a fluid passage, wherein the catecholamine sensor includes:
an oxidation electrode formed in the fluid passage, for oxidizing the catecholamine and the measurement interference material contained in the measurement sample;
a reduction electrode for reducing the catecholamine, formed at a further down stream from the oxidation electrode in the fluid passage and
a detection electrode for detecting the catecholamine, formed at a further down stream from the reduction electrode in the fluid passage.

21. The sensor according to claim 2, wherein the split-ring resonator is positioned to be spaced apart from a center of the microstrip transmission line, and a width of a portion of the microstrip transmission line formed near the split-ring resonator is smaller than a width of the other portion of the microstrip transmission line that is not close to the split-ring resonator.

22. The sensor according to claim 3, wherein the split-ring resonator is positioned to be spaced apart from a center of the microstrip transmission line, and a width of a portion, of the microstrip transmission line formed near the split-ring resonator is smaller than a width of the other portion of the microstrip transmission line that is not close to the split-ring resonator.

23. The sensor according to claim 21, wherein a time-varying electromagnetic field is generated by applying a microwave AC voltage at both ends of the microstrip transmission. line, and a resonance is occurred by an induced electromagnetic force which is generated when the time-varying electromagnetic field enters into the split-ring resonator.

24. The sensor according to claim 22, wherein a time-varying electromagnetic field is generated by applying a microwave AC voltage at both ends of the microstrip transmission line, and a resonance is occurred by an induced electromagnetic force which is generated when the time-varying electromagnetic field enters into the split-ring resonator.

25. The sensor according to claim 2, wherein the split-ring resonator is formed of an inner pattern, one side of which is open, and an outer pattern positioned outside of the inner pattern, the other side of which is open, and the inner pattern and the outer pattern are formed in any one of a circle, a rectangle, a triangle, an oval and a diamond.

26. The sensor according to claim 3, wherein the split-ring resonator is formed of an inner pattern, one side of which is open, and an outer pattern positioned outside of the inner pattern, the other side of which is open, and the inner pattern and the outer pattern are formed in any one or a circle, a rectangle, a triangle, an oval and a diamond.

27. The system according to claim 11, wherein the ring resonator is positioned to be spaced apart from a center of a microstrip transmission line, and a width of a portion of the microstrip transmission line formed near the ring resonator is smaller than a width of the other portion of the microstrip transmission line that is not close to the split-ring resonator.

28. The system according to claim wherein a time varying electromagnetic field is generated by applying a microwave AC voltage at both ends of the microstrip transmission line, and a resonance is occurred by an induced electromagnetic force which is generated when the time-varying electromagnetic field enters into the split-ring resonator.
